(19) United States
(12) Patent Application Publication
(10) Pub. No.: US 2019/0138002 A1
(43) Pub. Date: May 9, 2019

(54) VEHICLE CONTROL SYSTEM, VEHICLE CONTROL METHOD, AND VEHICLE CONTROL PROGRAM

(71) Applicant: HONDA MOTOR CO., LTD., Minato-ku, Tokyo (JP)

(72) Inventors: Yoshitaka Mimura, Wako-shi (JP); Naotaka Kumakiri, Wako-shi (JP)

(73) Assignee: HONDA MOTOR CO., LTD., Minato-ku, Tokyo (JP)

(21) Appl. No.: 16/095,973

(22) PCT Filed: Apr. 28, 2016
(86) PCT No.: PCT/JP2016/063446

§ 371 Date: Oct. 24, 2018

(51) Int. Cl. G05D 1/00; G05D 1/02; B60W 50/14; B60W 10/20

(52) U.S. Cl. CPC G05D 1/0061; G05D 1/0223; B60W 2050/143; B60W 10/20; B60W 50/14

(57) ABSTRACT

A vehicle control system includes: an automated driving control unit automatically performing at least one of speed control and steering control of a vehicle by executing one of a plurality of driving modes of which degrees of automated driving are different from each other; one or more detection devices used for detecting a surrounding environment of the vehicle; and a management unit managing states of the one or more detection devices and outputting a request used for causing a vehicle occupant of the vehicle to monitor a part of the surroundings of the vehicle in accordance with a change in the states of the one or more detection devices by controlling an output unit.

### TECHNICAL FIELD

The present invention relates to a vehicle control system, a vehicle control method, and a vehicle control program.

### BACKGROUND ART

In recent years, technologies for automatically performing at least one of speed control and steering control of a subject vehicle (hereinafter, referred to as automated driving) have been researched. In relation with this, there are techniques for requesting a driver to perform manual driving in a section in which automated driving cannot be executed (for example, Patent Literature 1).

### CITATION LIST

### Patent Literature

### Patent Literature 1

Japanese Unexamined Patent Application, First Publication No. 2015-206655

### SUMMARY OF INVENTION

### Technical Problem

While an automated driving system enables automatic running using a combination of various sensors (detection devices), there is a limit in monitoring the surroundings using only sensors for changes in environments during driving such as weather conditions. Thus, in a case in which a detection level of a sensor that detects a partial area of the surroundings is lowered in accordance with a change in the surrounding status during driving, in a conventional technology, it is necessary to turn off the entire automated driving, and, as a result, there are cases in which the driving burden of a vehicle occupant increases.

The present invention has been realized in consideration of such situations, and one object thereof is to provide a vehicle control system, a vehicle control method, and a vehicle control program capable of continuing automated driving by allowing a vehicle occupant to perform a part of monitoring of the surroundings in the automated driving.

### Solution to Problem

An invention described in claim 1 is a vehicle control system (100) including: an automated driving control unit (120) automatically performing at least one of speed control and steering control of a vehicle by executing one of a plurality of driving modes of which degrees of automated driving are different from each other; one or more detection devices (DD) used for detecting a surrounding environment of the vehicle; and a management unit (172) managing states of the one or more detection devices and outputting a request used for causing a vehicle occupant of the vehicle to monitor a part of the surroundings of the vehicle in accordance with a change in the states of the one or more detection devices by controlling an output unit (70).

An invention described in claim 2 is the vehicle control system according to claim 1, in which the management unit outputs a request used for causing the vehicle occupant of the vehicle to monitor an area corresponding to the change in the state of the one or more detection devices by controlling the output unit.

An invention described in claim 3 is the vehicle control system according to claim 1, in which the management unit manages reliability of a detection result for each of the one or more detection devices or for each of detection areas of the one or more detection devices and outputs a request used for causing the vehicle occupant of the vehicle to monitor a part of the surroundings of the vehicle in accordance with a decrease in the reliability by controlling the output unit.

An invention described in claim 4 is the vehicle control system according to claim 1, in which, in a case in which redundancy is decreased for the detection areas of the one or more detection devices, the management unit outputs a request used for causing the vehicle occupant of the vehicle to monitor a part of the surroundings of the vehicle by controlling the output unit.

An invention described in claim 5 is the vehicle control system according to claim 1, in which, the output unit further includes a screen displaying an image, and the management unit displays a target area for monitoring the surroundings for a vehicle occupant of the vehicle and an area other than the target area for monitoring the surroundings on the screen of the output unit to be distinguished from each other.

An invention described in claim 6 is the vehicle control system according to claim 1, in which the output unit outputs at least one of a monitoring target, a monitoring technique, and a monitoring area requested for the vehicle occupant.

An invention described in claim 7 is the vehicle control system according to claim 1, in which, in a case in which a state in which the vehicle occupant of the vehicle is monitoring a part of the surroundings of the vehicle is determined by the management unit, the automated driving control unit continues a driving mode that is a driving mode before the change in the state of the detection device.

An invention described in claim 8 is the vehicle control system according to claim 1, in which, in a case in which a state in which the vehicle occupant of the vehicle is not monitoring a part of the surroundings of the vehicle is determined by the management unit, the automated driving control unit performs control of switching from a driving mode of which a degree of automated driving is high to a driving mode of which a degree of automated driving is low.

An invention described in claim 9 is the vehicle control system according to claim 1, in which, in a case in which the state of the detection device is returned to the state before the change, the management unit outputs information indicating release of the vehicle occupant's monitoring by controlling the output unit.

An invention described in claim 10 is a vehicle control method using an in-vehicle computer, the vehicle control method including: automatically performing at least one of speed control and steering control of a vehicle by executing one of a plurality of driving modes of which degrees of automated driving are different from each other; detecting a surrounding environment of the vehicle using one or more detection devices; and managing states of the one or more detection devices and outputting a request used for causing a vehicle occupant of the vehicle to monitor a part of the surroundings of the vehicle in accordance with a change in the states of the one or more detection devices by controlling an output unit.

An invention described in claim 11 is a vehicle control program causing an in-vehicle computer to execute: automatically performing at least one of speed control and steering control of a vehicle by executing one of a plurality of driving modes of which degrees of automated driving are different from each other; detecting a surrounding environment of the vehicle using one or more detection devices; and managing states of the one or more detection devices and outputting a request used for causing a vehicle occupant of the vehicle to monitor a part of the surroundings of the vehicle in accordance with a change in the states of the one or more detection devices by controlling an output unit.

### Advantageous Effects of Invention

According to the inventions described in claims 1, 2, 10, and 11, a part of the surroundings of the vehicle is monitored, and accordingly, a burden on the vehicle occupant can be alleviated.

According to the invention described in claim 3, the vehicle occupant of the vehicle is caused to perform monitoring on the basis of the reliability of a detection result acquired by the detection device, and accordingly, safety at the time of automated driving can be secured.

According to the invention described in claim 4, the vehicle occupant of the vehicle is caused to perform monitoring on the basis of the redundancy for detection areas of the detection devices, and accordingly, safety at the time of automated driving can be secured.

According to the invention described in claim 5, the vehicle occupant can easily recognize a target area for monitoring the surroundings by referring to the screen of the output unit.

According to the invention described in claim 6, the vehicle occupant can easily recognize a monitoring target, a monitoring technique, a monitoring area, and the like by referring to the screen of the output unit.

According to the invention described in claim 7, the degree of automated driving is prevented from being frequently decreased due to the state of the vehicle or the outside of the vehicle.

According to the invention described in claim 8, the safety of the vehicle can be maintained.

According to the invention described in claim 9, the vehicle occupant can easily recognize that the monitoring has been released.

### BRIEF DESCRIPTION OF DRAWINGS

FIG. 1 is a diagram illustrating constituent elements of a vehicle in which a vehicle control system 100 according to an embodiment is mounted.

FIG. 2 is functional configuration diagram focusing on a vehicle control system 100 according to an embodiment.

FIG. 3 is a configuration diagram of an HMI 70.

FIG. 4 is a diagram illustrating a view in which a relative position of a subject vehicle M with respect to a running lane L1 is recognized by a subject vehicle position recognizing unit 140.

FIG. 5 is a diagram illustrating one example of an action plan generated for a certain section.

FIG. 6 is a diagram illustrating one example of the configuration of a locus generating unit 146.

FIG. 7 is a diagram illustrating one example of candidates for a locus generated by a locus candidate generating unit 146B.

FIG. 8 is a diagram in which candidates for a locus generated by a locus candidate generating unit 146B are represented using locus points K.

FIG. 9 is a diagram illustrating a lane change target position TA.

FIG. 10 is a diagram illustrating a speed generation model of a case in which the speeds of three surrounding vehicles are assumed to be constant.

FIG. 11 is a diagram illustrating an example of the functional configuration of an HMI control unit 170.

FIG. 12 is a diagram illustrating one example of surrounding monitoring information.

FIG. 13 illustrates one example of operation permission/prohibition information 188 for each mode.

FIG. 14 is a diagram illustrating a view of the inside of a subject vehicle M.

FIG. 15 is a diagram illustrating an example of an output screen according to this embodiment.

FIG. 16 is a diagram (1) illustrating an example of a screen on which information requesting monitoring of the surroundings is displayed.

FIG. 17 is a diagram (2) illustrating an example of a screen on which information requesting monitoring of the surroundings is displayed.

FIG. 18 is a diagram (3) illustrating an example of a screen on which information requesting monitoring of the surroundings is displayed.

FIG. 19 is a diagram illustrating an example of a screen on which information representing release of a monitoring state is displayed.

FIG. 20 is a diagram illustrating an example of a screen on which information representing a driving mode switching request is displayed.

FIG. 21 is a flowchart illustrating one example of a surrounding monitoring request process.

### DESCRIPTION OF EMBODIMENTS

Hereinafter, a vehicle control system, a vehicle control method, and a vehicle control program according to embodiments of the present invention will be described with reference to the drawings.

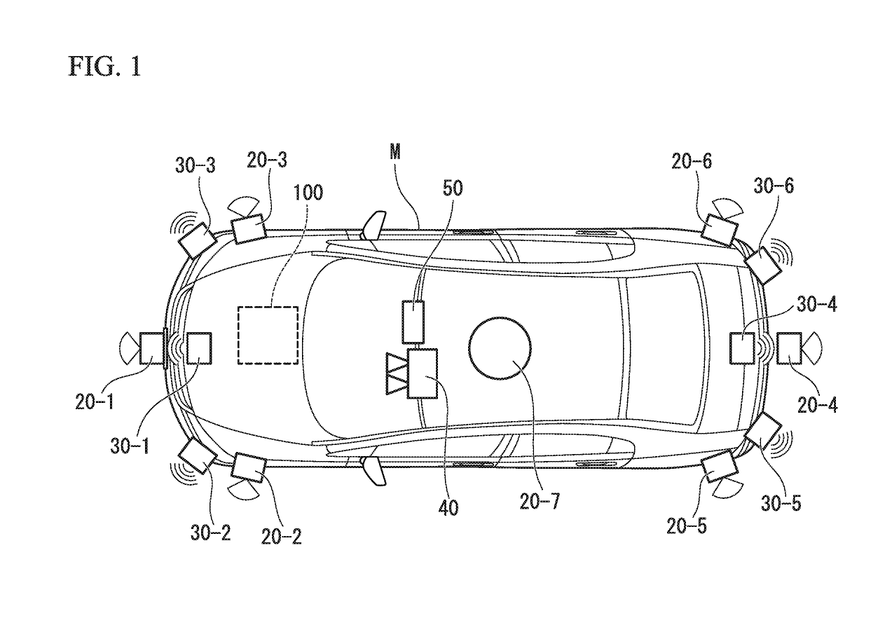

FIG. 1 is a diagram illustrating constituent elements of a vehicle (hereinafter referred to as a subject vehicle M) in which a vehicle control system 100 according to an embodiment is mounted. A vehicle in which the vehicle control system 100 is mounted, for example, is a vehicle with two wheels, three wheels, four wheels, or the like and includes an automobile having an internal combustion engine such as a diesel engine or a gasoline engine as its power source, an electric vehicle having a motor as its power source, a hybrid vehicle equipped with both an internal combustion engine and a motor, and the like. The electric vehicle described above, for example, is driven using electric power discharged by a cell such as a secondary cell, an alcohol fuel cell, a metal fuel cell, an alcohol fuel cell, or the like.

As illustrated in FIG. 1, sensors such as finders 20-1 to 20-7, radars 30-1 to 30-6, a camera 40, and the like, a navigation device 50, and a vehicle control system 100 are mounted in the subject vehicle M.

Each of the finders 20-1 to 20-7, for example, is a light detection and ranging or a laser imaging detection and ranging (LIDAR) device measuring a distance to a target by measuring scattered light from emitted light. For example, the finder 20-1 is mounted on a front grille or the like, and the finders 20-2 and 20-3 are mounted on side faces of a vehicle body, door mirrors, inside head lights, near side lights, or the like. The finder 20-4 is mounted in a trunk lid or the like, and the finders 20-5 and 20-6 are mounted on side faces of the vehicle body, inside tail lamps or the like. Each of the finders 20-1 to 20-6 described above, for example, has a detection area of about 150 degrees with respect to a horizontal direction. In addition, the finder 20-7 is mounted on a roof or the like. For example, the finder 20-7 has a detection area of 360 degrees with respect to a horizontal direction.

The radars 30-1 and 30-4, for example, are long-distance millimeter wave radars having a wider detection area in a depth direction than that of the other radars. In addition, the radars 30-2, 30-3, 30-5, and 30-6 are middle-distance millimeter wave radars having a narrower detection area in a depth direction than that of the radars 30-1 and 30-4.

Hereinafter, in a case in which the finders 20-1 to 20-7 are not particularly distinguished from each other, one thereof will be simply referred to as a “finder 20,” and, in a case in which the radars 30-1 to 30-6 are not particularly distinguished from each other, one thereof will be simply referred to as a “radar 30.” The radar 30, for example, detects an object using a frequency modulated continuous wave (FM-CW) system.

The camera (imaging unit) 40, for example, is a digital camera using a solid-state imaging device such as a charge coupled device (CCD), a complementary metal oxide semiconductor (CMOS), or the like. The camera 40 is mounted in an upper part of a front windshield, a rear face of an interior mirror, or the like. The camera 40, for example, repeats imaging of the side in front of the subject vehicle M periodically. The camera 40 may be a stereo camera including a plurality of cameras.

The configuration illustrated in FIG. 1 is merely one example, and a part of the configuration may be omitted, and other different components may be added.

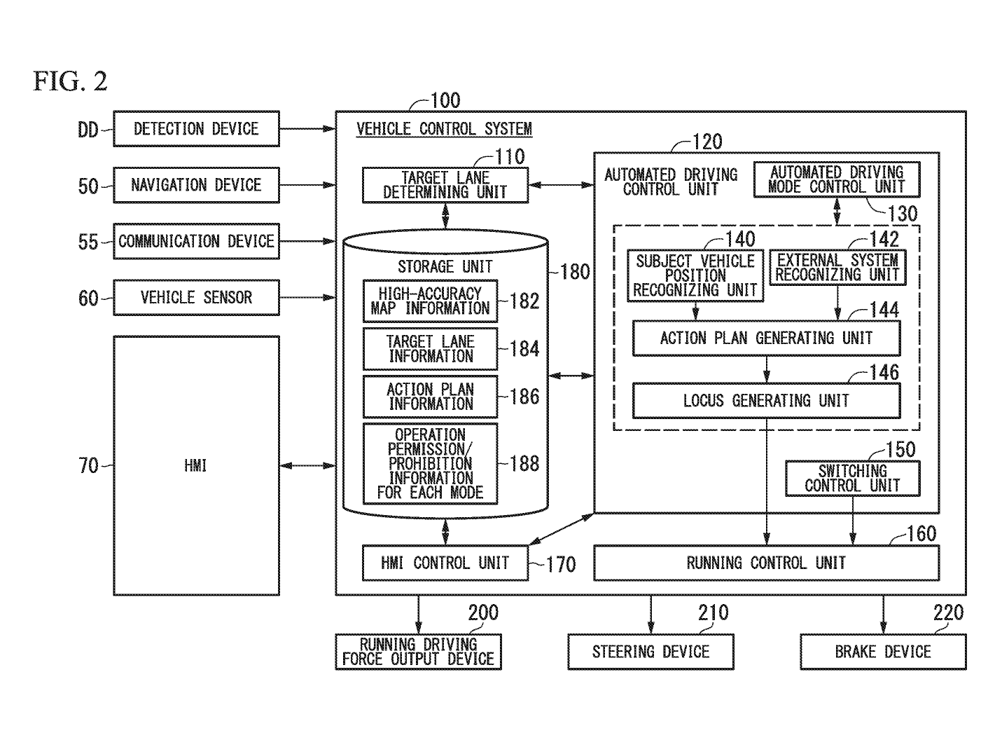

FIG. 2 is functional configuration diagram focusing on a vehicle control system 100 according to an embodiment. In the subject vehicle M, one or more detection devices DD including finders 20, radars 30, a camera 40, and the like, a navigation device 50, a communication device 55, a vehicle sensor 60, a human machine interface (HMI) 70, a vehicle control system 100, a running driving force output device 200, a steering device 210, and a brake device 220 are mounted. Such devices and units are interconnected through a multiple-communication line such as a controller area network (CAN) communication line, a serial communication line, a radio communication network, or the like. A vehicle control system described in the claims may represent not only the “vehicle control system 100” but may include components (a detection device DD, an HMI 70, and the like) other than the vehicle control system 100.

The detection device DD detects a surrounding environment of the subject vehicle M. In the detection device DD, for example, a graphics processing unit (GPU) recognizing objects and the like by analyzing an image captured by the camera 40 and the like may be included. The detection device DD continuously detects the surrounding environment and outputs a result of the detection to the automated driving control unit 120.

The navigation device 50 includes a global navigation satellite system (GNSS) receiver, map information (navigation map), a touch panel-type display device functioning as a user interface, a speaker, a microphone, and the like. The navigation device 50 identifies a location of the subject vehicle M using the GNSS receiver and derives a route from the location to a destination designated by a user (a vehicle occupant or the like). The route derived by the navigation device 50 is provided to the target lane determining unit 110 of the vehicle control system 100. The location of the subject vehicle M may be identified or complemented by an inertial navigation system (INS) using an output of the vehicle sensor 60. In addition, when the vehicle control system 100 implements a manual driving mode, the navigation device 50 performs guidance using speech or a navigation display for a route to the destination. Components used for identifying the location of the subject vehicle M may be disposed to be independent from the navigation device 50. In addition, the navigation device 50, for example, may be realized by a function of a terminal device such as a smartphone, a tablet terminal, or the like held by a vehicle occupant (occupant) of the subject vehicle M or the like. In such a case, information is transmitted and received using wireless or wired communication between the terminal device and the vehicle control system 100.

The communication device 55, for example, performs radio communication using a cellular network, a Wi-Fi network, Bluetooth (registered trademark), a dedicated short range communication (DSRC), or the like.

The vehicle sensor 60 includes a vehicle speed sensor detecting a vehicle speed, an acceleration sensor detecting an acceleration, a yaw rate sensor detecting an angular velocity around a vertical axis, an azimuth sensor detecting the azimuth of the subject vehicle M, and the like.

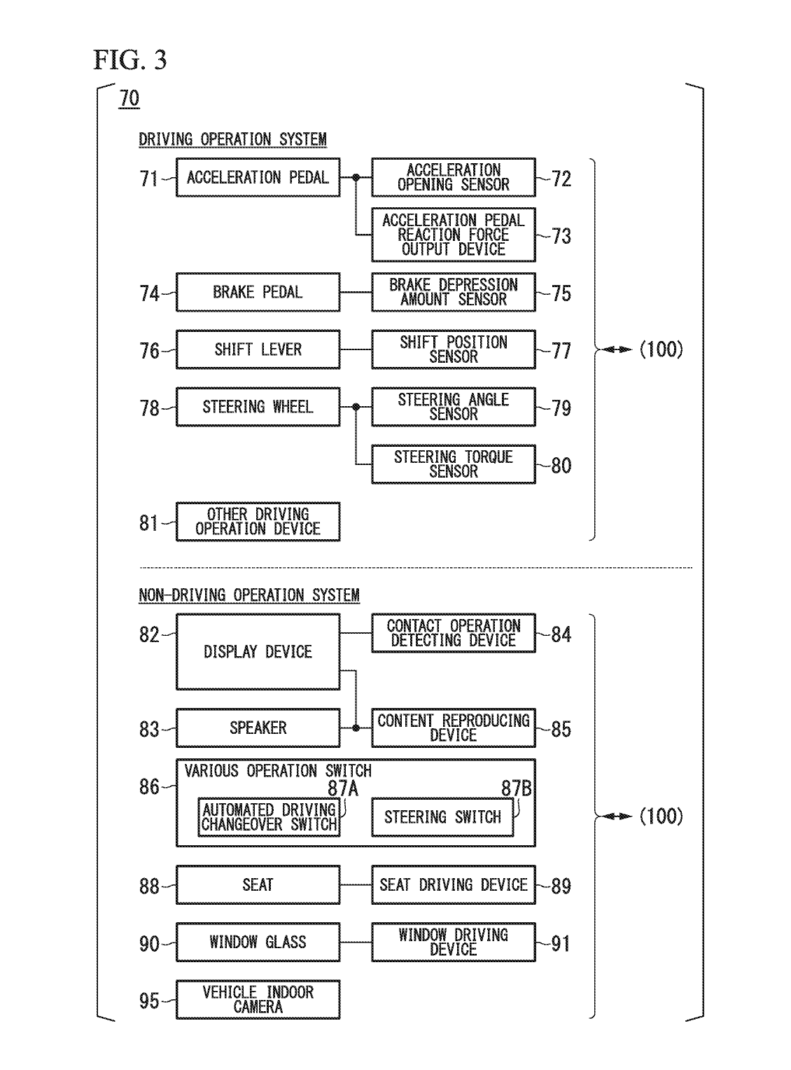

FIG. 3 is a configuration diagram of the HMI 70. The HMI 70, for example, includes a configuration of a driving operation system and a configuration of a non-driving operation system. A boundary therebetween is not clear, and a configuration of a driving operation system may have a function of a non-driving operation system (or the reverse). A part of the HMI 70 is one example of an “operation accepting unit” and is also one example of an “output unit.”

For the configuration of the driving operation system, the HMI 70, for example, includes an acceleration pedal 71, an acceleration opening degree sensor 72, an acceleration pedal reaction force output device 73, a brake pedal 74, a brake depression amount sensor (or a master pressure sensor or the like) 75, a shift lever 76, a shift position sensor 77, a steering wheel 78, a steering angle sensor 79, a steering torque sensor 80, and other driving operation devices 81.

The acceleration pedal 71 is an operator that is used for receiving an acceleration instruction (or a deceleration instruction using a returning operation) from a vehicle occupant. The acceleration opening degree sensor 72 detects a depression amount of the acceleration pedal 71 and outputs an acceleration opening degree signal representing the depression amount to the vehicle control system 100. In addition, instead of outputting the acceleration opening degree signal to the vehicle control system 100, the acceleration opening degree signal may be directly output to the running driving force output device 200, the steering device 210, or the brake device 220. This similarly applies also to the configuration of the other driving operation system described below. The acceleration pedal reaction force output device 73, for example, outputs a force in a direction opposite to an operation direction (operation reaction force) to the acceleration pedal 71 in response to a direction from the vehicle control system 100.

The brake pedal 74 is an operator that is used for receiving a deceleration instruction from a vehicle occupant. The brake depression amount sensor 75 detects a depression amount (or a depressing force) of the brake pedal 74 and outputs a brake signal representing a result of the detection to the vehicle control system 100.

The shift lever 76 is an operator that is used for receiving an instruction for changing a shift level from a vehicle occupant. The shift position sensor 77 detects a shift level instructed from a vehicle occupant and outputs a shift position signal representing a result of the detection to the vehicle control system 100.

The steering wheel 78 is an operator that is used for receiving a turning instruction from a vehicle occupant. The steering angle sensor 79 detects an operation angle of the steering wheel 78 and outputs a steering angle signal representing a result of the detection to the vehicle control system 100. The steering torque sensor 80 detects a torque applied to the steering wheel 78 and outputs a steering torque signal representing a result of the detection to the vehicle control system 100.

The other driving operation devices 81, for example, are buttons, a joystick, a dial switch, a graphical user interface (GUI) switch, and the like. The other driving operation devices 81 receive an acceleration instruction, a deceleration instruction, a turning instruction, and the like and output the received instructions to the vehicle control system 100.

For the configuration of the non-driving operation system, the HMI 70, for example, includes a display device 82, a speaker 83, a contact operation detecting device 84, a content reproducing device 85, various operation switches 86, a seat 88, a seat driving device 89, a window glass 90, a window driving device 91, and a vehicle indoor camera (imaging unit) 95.

The display device 82, for example, is a liquid crystal display (LCD), an organic electroluminescence (EL) display device, or the like attached to an arbitrary position facing an assistant driver's seat or a rear seat. In addition, the display device 82 may be a head up display (HUD) that projects an image onto a front windshield or any other window. The speaker 83 outputs speech. In a case in which the display device 82 is a touch panel, the contact operation detecting device 84 detects a contact position (touch position) on a display screen of the display device 82 and outputs the detected contact position to the vehicle control system 100. On the other hand, in a case in which the display device 82 is not a touch panel, the contact operation detecting device 84 may be omitted.

The content reproducing device 85, for example, includes a digital versatile disc (DVD) reproduction device, a compact disc (CD) reproduction device, a television set, a device for generating various guidance images, and the like. A part or whole of each of the display device 82, the speaker 83, the contact operation detecting device 84, and the content reproducing device 85 may be configured to be shared by the navigation device 50.

The various operation switches 86 are disposed at arbitrary positions inside a vehicle cabin. The various operation switches 86 include an automated driving changeover switch 87A that instructs starting (or starting in the future) and stopping of automated driving and a steering switch 87B that performs switching between output contents of each output unit (for example, the navigation device 50, the display device 82, or the content reproducing device 85) or the like. Each of the automated driving changeover switch 87A and the steering switch 87B may be any one of a graphical user interface (GUI) switch and a mechanical switch. In addition, the various operation switches 86 may include switches used for driving the seat driving device 89 and the window driving device 91. When an operation is accepted from a vehicle occupant, the various operation switches 86 output an operation signal to the vehicle control system 100.

The seat 88 is a seat on which a vehicle occupant sits. The seat driving device 89 freely drives a reclining angle, a forward/backward position, a yaw rate, and the like of the seat 88. The window glass 90, for example, is disposed in each door. The window driving device 91 drives opening and closing of the window glass 90.

The vehicle indoor camera 95 is a digital camera that uses solid-state imaging devices such as CCDs or CMOSs. The vehicle indoor camera 95 is attached to a position such as a rearview mirror, a steering boss unit, or an instrument panel at which at least a head part of a vehicle occupant performing a driving operation can be imaged. The vehicle indoor camera 95, for example, repeatedly images a vehicle occupant periodically.

Before description of the vehicle control system 100, the running driving force output device 200, the steering device 210, and the brake device 220 will be described.

The running driving force output device 200 outputs a running driving force (torque) used for running the vehicle to driving wheels. For example, the running driving force output device 200 includes an engine, a transmission, and an engine control unit (ECU) controlling the engine in a case in which the subject vehicle M is an automobile having an internal combustion engine as its power source, includes a running motor and a motor ECU controlling the running motor in a case in which the subject vehicle M is an electric vehicle having a motor as its power source, and includes an engine, a transmission, an engine ECU, a running motor, and a motor ECU in a case in which the subject vehicle M is a hybrid vehicle. In a case in which the running driving force output device 200 includes only an engine, the engine ECU adjusts a throttle opening degree, a shift level, and the like of the engine in accordance with information input from a running control unit 160 to be described later. On the other hand, in a case in which the running driving force output device 200 includes only a running motor, the motor ECU adjusts a duty ratio of a PWM signal given to the running motor in accordance with information input from the running control unit 160. In a case in which the running driving force output device 200 includes an engine and a running motor, an engine ECU and a motor ECU control a running driving force in cooperation with each other in accordance with information input from the running control unit 160.

The steering device 210, for example, includes a steering ECU and an electric motor. The electric motor, for example, changes the direction of a steering wheel by applying a force to a rack and pinion mechanism. The steering ECU changes the direction of the steering wheels by driving the electric motor in accordance with information input from the vehicle control system 100 or information of a steering angle or a steering torque that is input.

The brake device 220, for example, is an electric servo brake device including a brake caliper, a cylinder delivering hydraulic pressure to the brake caliper, an electric motor generating hydraulic pressure in the cylinder, and a brake control unit. The brake control unit of the electric servo brake device performs control of the electric motor in accordance with information input from the running control unit 160 such that a brake torque according to a braking operation is output to each vehicle wheel. The electric servo brake device may include a mechanism delivering hydraulic pressure generated by an operation of the brake pedal to the cylinder through a master cylinder as a backup. In addition, the brake device 220 is not limited to the electric servo brake device described above and may be an electronic control-type hydraulic brake device. The electronic control-type hydraulic brake device delivers hydraulic pressure of the master cylinder to the cylinder by controlling an actuator in accordance with information input from the running control unit 160. In addition, the brake device 220 may include a regenerative brake using the running motor which can be included in the running driving force output device 200.

### [Vehicle Control System]

Hereinafter, the vehicle control system 100 will be described. The vehicle control system 100, for example, is realized by one or more processors or hardware having functions equivalent thereto. The vehicle control system 100 may be configured by combining an electronic control unit (ECU), a micro-processing unit (MPU), or the like in which a processor such as a central processing unit (CPU), a storage device, and a communication interface are interconnected through an internal bus.

Referring to FIG. 2, the vehicle control system 100, for example, includes a target lane determining unit 110, an automated driving control unit 120, a running control unit 160, and a storage unit 180. The automated driving control unit 120, for example, includes, an automated driving mode control unit 130, a subject vehicle position recognizing unit 140, an external system recognizing unit 142, an action plan generating unit 144, a locus generating unit 146, and a switching control unit 150.

Some or all of the target lane determining unit 110, each unit of the automated driving control unit 120, the running control unit 160, and the HMI control unit 170 are realized by a processor executing a program (software). In addition, some or all of these may be realized by hardware such as a large scale integration (LSI) or an application specific integrated circuit (ASIC) or may be realized by combining software and hardware.

In the storage unit 180, for example, information such as high-accuracy map information 182, target lane information 184, action plan information 186, operation permission/prohibition information 188 for each mode, and the like is stored. The storage unit 180 is realized by a read only memory (ROM), a random access memory (RAM), a hard disk drive (HDD), a flash memory, or the like. A program executed by the processor may be stored in the storage unit 180 in advance or may be downloaded from an external device through in-vehicle internet facilities or the like. In addition, a program may be installed in the storage unit 180 by mounting a portable-type storage medium storing the program in a drive device not illustrated in the drawing. Furthermore, the computer (in-vehicle computer) of the vehicle control system 100 may be distributed using a plurality of computer devices.

The target lane determining unit 110, for example, is realized by an MPU. The target lane determining unit 110 divides a route provided from the navigation device 50 into a plurality of blocks (for example, divides the route at every 100 [m] in the vehicle advancement direction) and determines a target lane for each block by referring to the high-accuracy map information 182. The target lane determining unit 110, for example, determines a lane, in which the subject vehicle runs, represented using a position from the left side. For example, in a case in which a branching point, a merging point, or the like is present in the route, the target lane determining unit 110 determines a target lane such that the subject vehicle M can run in a running route that is rational for advancing to a branching destination. The target lane determined by the target lane determining unit 110 is stored in the storage unit 180 as target lane information 184.

The high-accuracy map information 182 is a map information having a higher accuracy than that of the navigation map included in the navigation device 50. The high-accuracy map information 182, for example, includes information of the center of a lane or information of boundaries of a lane and the like. In addition, in the high-accuracy map information 182, road information, traffic regulations information, address information (an address and a zip code), facilities information, telephone number information, and the like may be included. In the road information, information representing a type of road such as an expressway, a toll road, a national road, or a prefectural road and information such as the number of lanes of a road, a width of each lane, a gradient of a road, the position of a road (three-dimensional coordinates including longitude, latitude, and a height), a curvature of the curve of a lane, locations of merging and branching points of lanes, signs installed on a road, and the like are included. In the traffic regulations information, information of closure of a lane due to roadwork, traffic accidents, congestion, or the like is included.

By executing one of a plurality of driving modes of which degrees of automated driving are different from each other, the automated driving control unit 120 automatically performing at least one of speed control and steering control of the subject vehicle M. In addition, in a case in which a state in which a vehicle occupant of the subject vehicle M is monitoring the surroundings (monitoring at least a part of the surroundings of the subject vehicle M) is determined by the HMI control unit 170 to be described later, the automated driving control unit 120 continues to execute the driving mode that has been executed before the determination. On the other hand, in a case in which a state in which a vehicle occupant of the subject vehicle M is not monitoring the surroundings is determined by the HMI control unit 170, the automated driving control unit 120 performs control of switching from a driving mode of which the degree of automated driving is high to a driving mode of which the degree of automated driving is low.

The automated driving mode control unit 130 determines a mode of automated driving performed by the automated driving control unit 120. Modes of automated driving according to this embodiment include the following modes. The followings are merely examples, and the number of the modes of automated driving may be arbitrarily determined.

### [Mode A]

A mode A is a mode of which the degree of automated driving is the highest. In a case in which the mode A is executed, the entire vehicle control such as complicated merging control is automatically performed, and accordingly, a vehicle occupant does not need to monitor the vicinity or the state of the subject vehicle M (an obligation of monitoring the surroundings is not required).

### [Mode B]

A mode B is a mode of which a degree of automated driving is the second highest next to the mode A. In a case in which the mode B is executed, generally, the entire vehicle control is automatically performed, but a driving operation of the subject vehicle M may be given over to a vehicle occupant in accordance with situations. For this reason, the vehicle occupant needs to monitor the vicinity and the state of the subject vehicle M (an obligation of monitoring the surroundings is required).

### [Mode C]

A mode C is a mode of which a degree of automated driving is the third highest next to the mode B. In a case in which the mode C is executed, a vehicle occupant needs to perform a checking operation according to situations on the HMI 70. In the mode C, for example, in a case in which a timing for a lane change is notified to a vehicle occupant, and the vehicle occupant performs an operation of instructing a lane change for the HMI 70, automatic lane change is performed. For this reason, the vehicle occupant needs to monitor the vicinity and the state of the subject vehicle M (an obligation of monitoring the surroundings is required). In addition, in this embodiment, a mode of which a degree of automated driving is the lowest, for example, may be a manual driving mode in which automated driving is not performed, and both speed control and steering control of the subject vehicle M are performed on the basis of an operation of a vehicle occupant of the subject vehicle M. In the case of the manual driving mode, naturally, an obligation of monitoring the surroundings is required for a driver.

The automated driving mode control unit 130 determines a mode of automated driving on the basis of a vehicle occupant's operation on the HMI 70, an event determined by the action plan generating unit 144, and a running mode determined by the locus generating unit 146. The mode of automated driving is notified to the HMI control unit 170. In addition, in the mode of automated driving, a limit according to the performance and the like of the detection device DD of the subject vehicle M may be set. For example, in a case in which the performance of the detection device DD is low, the mode A may not be executed. In addition, monitoring of the surroundings may be requested for a vehicle occupant with the mode A being maintained. In both modes, switching to a manual driving mode (overriding) can be made by performing an operation on the configuration of the driving operation system of the HMI 70.

The subject vehicle position recognizing unit 140 recognizes a lane (running lane) in which the subject vehicle M is running and a relative position of the subject vehicle M with respect to the running lane on the basis of the high-accuracy map information 182 stored in the storage unit 180 and information input from the finder 20, the radar 30, the camera 40, the navigation device 50, or the vehicle sensor 60.

For example, the subject vehicle position recognizing unit 140 compares a pattern of road partition lines recognized from the high-accuracy map information 182 (for example, an array of solid lines and broken lines) with a pattern of road partition lines in the vicinity of the subject vehicle M that has been recognized from an image captured by the camera 40, thereby recognizing a running lane. In the recognition, the position of the subject vehicle M acquired from the navigation device 50 or a result of the process executed by an INS may be additionally taken into account.

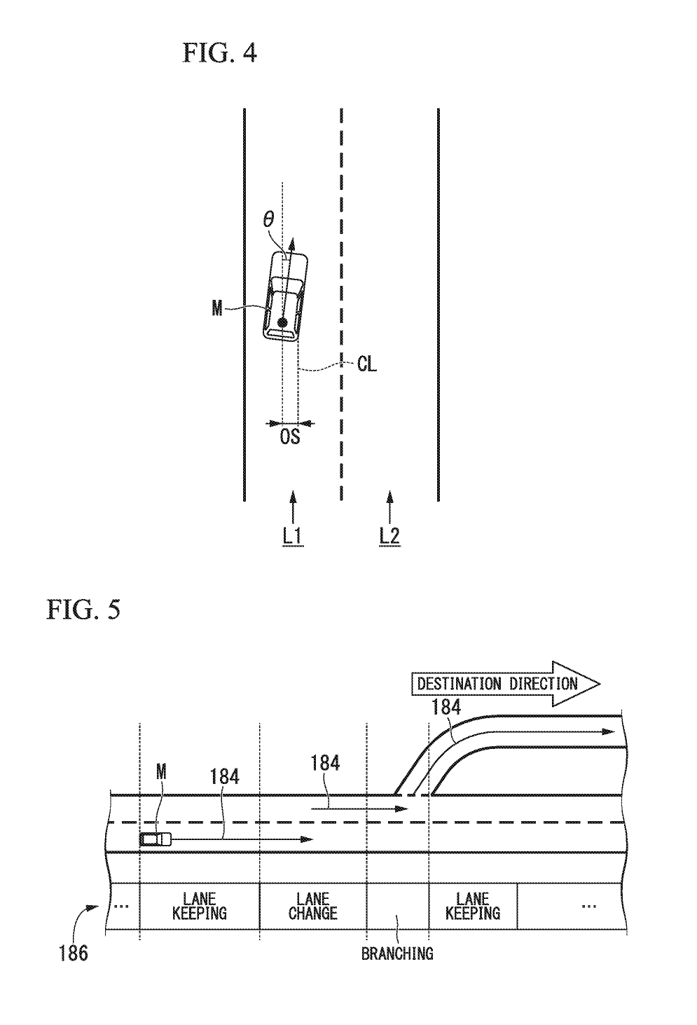

FIG. 4 is a diagram illustrating a view in which a relative position of a subject vehicle M with respect to a running lane L1 is recognized by the subject vehicle position recognizing unit 140. For example, the subject vehicle position recognizing unit 140 recognizes an offset OS of a reference point (for example, the center of gravity) of the subject vehicle M from the center CL of the running lane and an angle 0 of an advancement direction of the subject vehicle M formed with respect to a line along the center CL of the running lane as a relative position of the subject vehicle M with respect to the running lane L1. In addition, instead of this, the subject vehicle position recognizing unit 140 may recognize a position of a reference point on the subject vehicle M with respect to a side end part of the running lane L1 and the like as a relative position of the subject vehicle M with respect to the running lane. The relative position of the subject vehicle M recognized by a subject vehicle position recognizing unit 140 is provided to the target lane determining unit 110.

The external system recognizing unit 142 recognizes states of each surrounding vehicle such as a position, a speed, an acceleration, and the like thereof on the basis of information input from the finder 20, the radar 30, the camera 40, and the like. For example, a surrounding vehicle is a vehicle running in the vicinity of the subject vehicle M and is a vehicle running in the same direction as that of the subject vehicle M. The position of a surrounding vehicle may be represented as a representative point on another vehicle such as the center of gravity, a corner, or the like and may be represented by an area represented by the contour of another vehicle. The “state” of a surrounding vehicle is acquired on the basis of information of various devices described above and may include an acceleration of a surrounding vehicle and whether or not a lane is being changed (or whether or not a lane is to be changed). In addition, the external system recognizing unit 142 may recognize positions of a guard rail, a telegraph pole, a parked vehicle, a pedestrian, a fallen object, a crossing, a traffic signal, a sign board disposed near a construction site or the like, and other objects in addition to the surrounding vehicles.

The action plan generating unit 144 sets a start point of automated driving and/or a destination of the automated driving. The start point of automated driving may be the current position of the subject vehicle M or a point at which an operation instructing automated driving is performed. The action plan generating unit 144 generates an action plan for a section between the start point and a destination of the automated driving. The section is not limited thereto, and the action plan generating unit 144 may generate an action plan for an arbitrary section.

The action plan, for example, is configured of a plurality of events that are sequentially executed. The events, for example, include a deceleration event of decelerating the subject vehicle M, an acceleration event of accelerating the subject vehicle M, a lane keeping event of causing the subject vehicle M to run without deviating from a running lane, a lane changing event of changing a running lane, an overtaking event of causing the subject vehicle M to overtake a vehicle running ahead, a branching event of changing lane to a desired lane at a branching point or causing the subject vehicle M to run without deviating from a current running lane, a merging event of accelerating/decelerating the subject vehicle M (for example, speed control including one or both of acceleration and deceleration) and changing a running lane in a merging lane for merging into a main lane, and a handover event of transitioning to a manual driving mode to an automated driving mode at a start point of automated driving or transitioning from the automated driving mode to the manual driving mode at a planned end point of automated driving, and the like. The action plan generating unit 144 sets a lane changing event, a branching event, or a merging event at a place at which a target lane determined by the target lane determining unit 110 is changed. Information representing the action plan generated by the action plan generating unit 144 is stored in the storage unit 180 as action plan information 186.

FIG. 5 is a diagram illustrating one example of an action plan generated for a certain section. As illustrated in the drawing, the action plan generating unit 144 generates an action plan that is necessary for the subject vehicle M to run on a target lane indicated by the target lane information 184. In addition, the action plan generating unit 144 may dynamically change the action plan in accordance with a change in the status of the subject vehicle M regardless of the target lane information 184. For example, in a case in which a speed of a surrounding vehicle recognized during the running of the vehicle by the external system recognizing unit 142 exceeds a threshold, or a moving direction of a surrounding vehicle running on a lane adjacent to the own lane (running lane) is directed toward the direction of the own lane, the action plan generating unit 144 may change the event set in a driving section on which the subject vehicle M plans to run. For example, in a case in which an event is set such that a lane changing event is executed after a lane keeping event, when it is determined that a vehicle is running at a speed that is a threshold or more from the behind in a lane that is a lane change destination during the lane keeping event in accordance with a result of the recognition of the external system recognizing unit 142, the action plan generating unit 144 may change the next event after a lane keeping event from a lane changing event to a deceleration event, a lane keeping event, or the like. As a result, also in a case in which a change in the state of the external system occurs, the vehicle control system 100 can cause the subject vehicle M to safely run automatically.

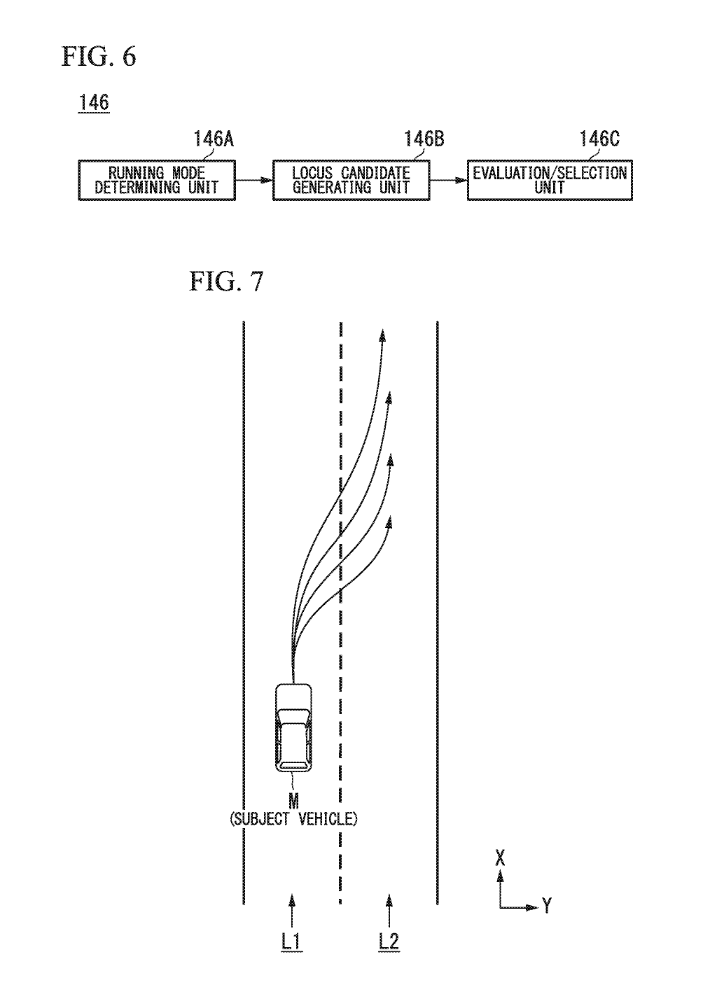

FIG. 6 is one example of the configuration of the locus generating unit 146. The locus generating unit 146, for example, includes a running mode determining unit 146A, a locus candidate generating unit 146B, and an evaluation/selection unit 146C.

When the lane keeping event is executed, the running mode determining unit 146A determines one running mode among constant-speed running, following running, low-speed following running, decelerating running, curve running, obstacle avoidance running, and the like. For example, in a case in which another vehicle is not present in front of the subject vehicle M, the running mode determining unit 146A determines constant-speed running as the running mode. In addition, in a case in which following running for a vehicle running ahead is to be executed, the running mode determining unit 146A determines following running as the running mode. In addition, in the case of a congested scene or the like, the running mode determining unit 146A determines low-speed following running as the running mode. Furthermore, in a case in which deceleration of a vehicle running ahead is recognized by the external system recognizing unit 142 or in a case in which an event of stopping, parking, or the like is to be executed, the running mode determining unit 146A determines decelerating running as the running mode. In addition, in a case in which the subject vehicle M is recognized to have reached a curved road by the external system recognizing unit 142, the running mode determining unit 146A determines the curve running as the running mode. Furthermore, in a case in which an obstacle is recognized in front of the subject vehicle M by the external system recognizing unit 142, the running mode determining unit 146A determines the obstacle avoidance running as the running mode.

The locus candidate generating unit 146B generates candidates for a locus on the basis of the running mode determined by the running mode determining unit 146A. FIG. 7 is a diagram illustrating one example of candidates for a locus that are generated by the locus candidate generating unit 146B. FIG. 7 illustrates candidates for loci generated in a case in which a subject vehicle M changes lanes from a lane L1 to a lane L2.

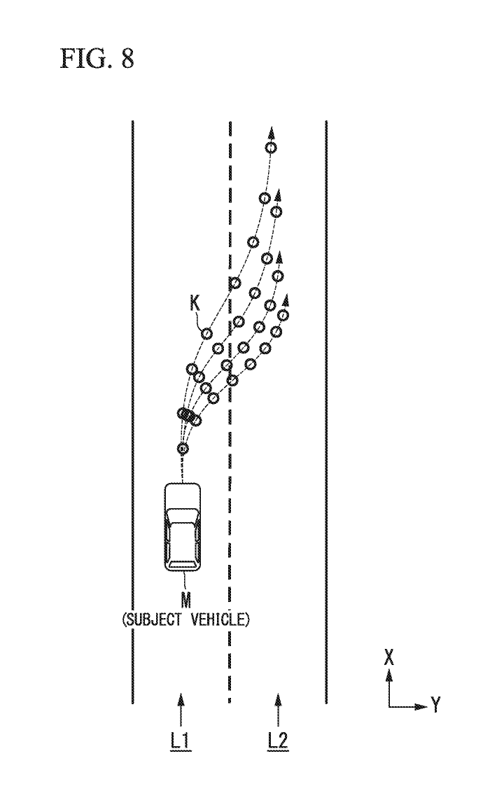

The locus candidate generating unit 146B, for example, determines loci as illustrated in FIG. 7 as aggregations of target positions (locus points K) that the reference position (for example, the center of gravity or the center of a rear wheel shaft) of the subject vehicle M will reach at predetermined times in the future. FIG. 8 is a diagram in which candidates for a locus generated by the locus candidate generating unit 146B are represented using locus points K. As a gap between the locus points K becomes wider, the speed of the subject vehicle M increases. On the other hand, as a gap between the locus points K becomes narrower, the speed of the subject vehicle M decreases. Thus, in a case in which acceleration is desired, the locus candidate generating unit 146B gradually increases the gap between the locus points K. On the other hand, in a case in which deceleration is desired, the locus candidate generating unit 146B gradually decreases the gap between the locus points.

In this way, since the locus points K include a speed component, the locus candidate generating unit 146B needs to give a target speed to each of the locus points K. The target speed is determined in accordance with the running mode determined by the running mode determining unit 146A.

Here, a technique for determining a target speed in a case in which a lane change (including branching) is performed will be described. The locus candidate generating unit 146B, first, sets a lane change target position (or a merging target position). The lane change target position is set as a relative position with respect to a surrounding vehicle and is for determining “surrounding vehicles between which a lane change is performed.” The locus candidate generating unit 146B determines a target speed of a case in which a lane change is performed focusing on three surrounding vehicles using the lane change target position as a reference.

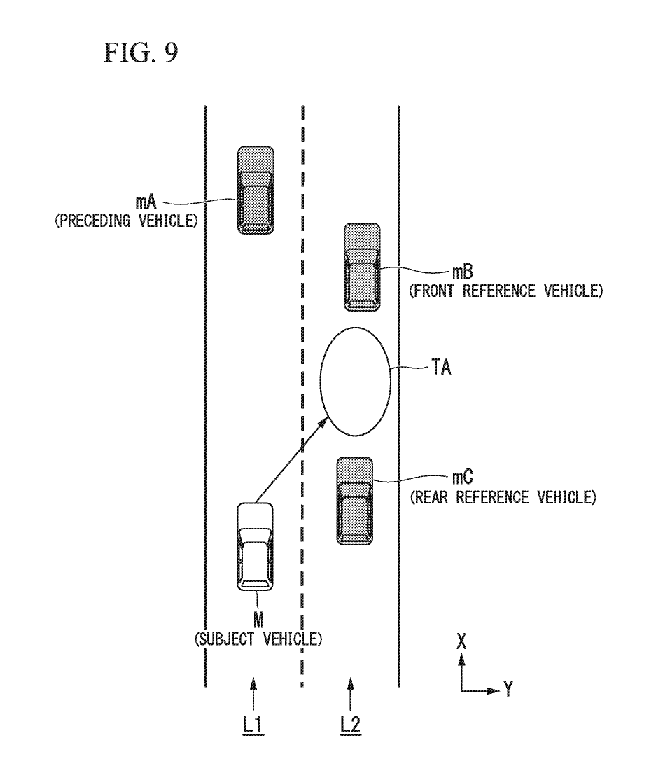

FIG. 9 is a diagram illustrating a lane change target position TA. In the drawing, an own lane L1 is illustrated, and an adjacent lane L2 is illustrated. Here, in the same lane as that of the subject vehicle M, a surrounding vehicle running immediately before the subject vehicle M will be defined as a vehicle mA running ahead, a surrounding vehicle running immediately before the lane change target position TA will be defined as a front reference vehicle mB, and a surrounding vehicle running immediately after the lane change target position TA will be defined as a rear reference vehicle mC. When the subject vehicle M needs to perform acceleration/deceleration for movement to the lateral side of the lane change target position TA, at this time, overtaking the vehicle mA running ahead needs to be avoided. For this reason, the locus candidate generating unit 146B predicts future states of the three surrounding vehicles and sets a target speed such that there is no interference with each of the surrounding vehicles.

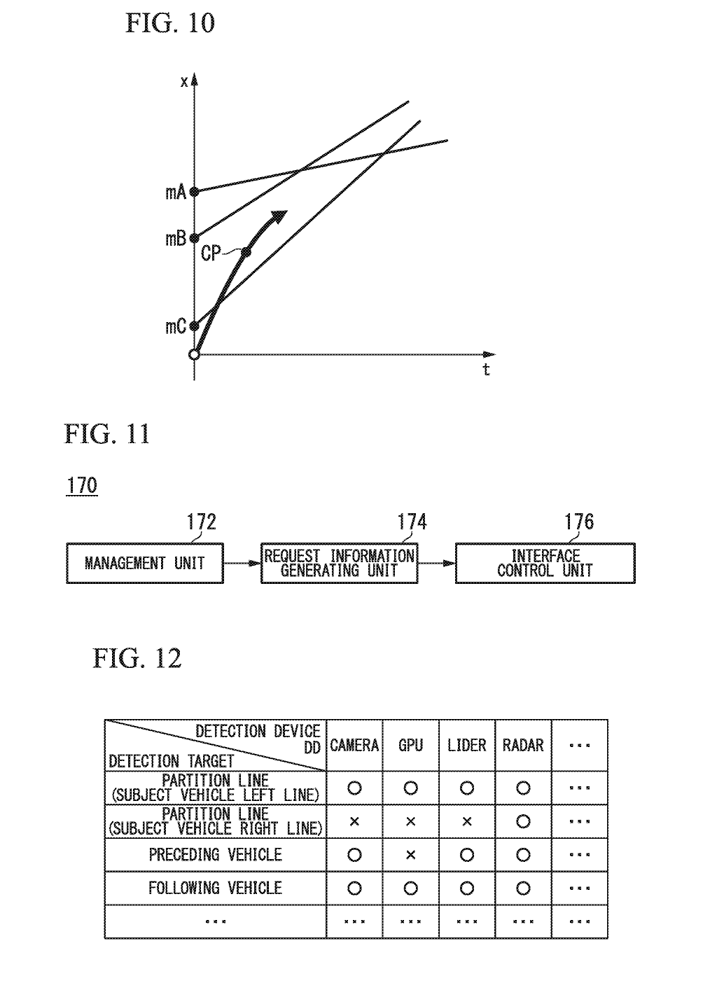

FIG. 10 is a diagram illustrating a speed generation model of a case in which the speeds of three surrounding vehicles are assumed to be constant. In the drawing, straight lines extending from mA, mB, and mC respectively represent displacements in the advancement direction in a case in which each of the surrounding vehicles is assumed to run at a constant speed. At a point CP at which the lane change is completed, the subject vehicle M needs to be present between the front reference vehicle mB and the rear reference vehicle mC and needs to be present behind the vehicle mA running ahead before that. Under such restrictions, the locus candidate generating unit 146B derives a plurality of time series patterns of the target speed until the lane change is completed. Then, by applying the time series patterns of the target speed to a model of a spline curve or the like, a plurality of candidates for loci as illustrated in FIG. 7 described above are derived. In addition, the movement patterns of the three surrounding vehicles are not limited to the constant speeds as illustrated in FIG. 10 and may be predicted on the premise of constant accelerations or constant jerks (derivatives of accelerations).

The evaluation/selection unit 146C performs evaluations for the generated candidates for the locus generated by the locus candidate generating unit 146B, for example, from two viewpoints of planning and safety and selects a locus to be output to the running control unit 160. From the viewpoint of the planning, for example, a locus is evaluated to be high in a case in which the followability for a plane that has already been generated (for example, an action plan) is high, and the total length of the locus is short. For example, in a case in which it is desirable to perform a lane change to the right side, a locus in which a lane change to the left side is performed once, and then, the subject vehicle is returned has a low evaluation. From the viewpoint of the safety, for example, in a case in which, at each locus point, a distance between the subject vehicle M and an object (a surrounding vehicle or the like) is long, and the acceleration/deceleration and the amounts of changes in the steering angle are small, the locus is evaluated as being high.

Here, the action plan generating unit 144 and the locus generating unit 146 described above are one example of a determination unit that determines a running locus and an acceleration/deceleration schedule of the subject vehicle M.

The switching control unit 150 performs switching between the automated driving mode and the manual driving mode on the basis of a signal input from the automated driving changeover switch 87A. In addition, the switching control unit 150 switches the driving mode from the automated driving mode to the manual driving mode on the basis of an operation instructing acceleration, deceleration, or steering for the configuration of the driving operation system of the HMI 70. For example, in a case in which a state in which the amount of operation represented by a signal input from the configuration of the driving operation system of the HMI 70 exceeds a threshold is continued for a reference time or more, the switching control unit 150 switches the driving mode from the automated driving mode to the manual driving mode (overriding). In addition, in a case in which an operation for the configuration of the driving operation system of the HMI 70 has not been detected for a predetermined time after the switching to the manual driving mode according to the overriding, the switching control unit 150 may return the driving mode to the automated driving mode.

The running control unit 160 performs at least one of speed control and steering control of the subject vehicle M on the basis of a schedule determined by the determination units (the action plan generating unit 144 and the locus generating unit 146) described above. Here, the speed control, for example, is control of acceleration including one or both of acceleration and deceleration of the subject vehicle M having an amount of speed change per unit time that is equal to or larger than a threshold. In addition, the speed control may include constant speed control of causing the subject vehicle M to run in a constant speed range.

For example, the running control unit 160 controls the running driving force output device 200, the steering device 210, and the brake device 220 such that the subject vehicle M passes through a running locus (locus information) generated (scheduled) by the locus generating unit 146 or the like at a scheduled time.

The HMI control unit 170, for example, continuously manages states of one or more detection devices DD and outputs a request for causing a vehicle occupant of the subject vehicle M to monitor a part of the surroundings of the subject vehicle M in accordance with changes in the states of one or more detection devices DD by controlling the HMI 70.

FIG. 11 is a diagram illustrating an example of the functional configuration of the HMI control unit 170. The HMI control unit 170 illustrated in FIG. 11 includes a management unit 172, a request information generating unit 174, and an interface control unit 176.

The management unit 172 manages the states of one or more detection devices DD used for detecting the surrounding environment of the subject vehicle M. In addition, the management unit 172 outputs a request for causing a vehicle occupant of the subject vehicle M to monitor a part of the surroundings of the subject vehicle M in accordance with changes in the states of detection devices DD by controlling the HMI 70.

For example, the management unit 172, for example, outputs a request for causing a vehicle occupant to monitor an area corresponding to a change in the state of the detection device DD to the request information generating unit 174. In addition, the management unit 172, for example, manages reliability of a detection result for each of one or more detection devices DD or for each of detection areas of one or more detection devices as a change in the state of the detection device DD and acquires a decrease in the reliability as a change in the state. The reliability, for example, is set in accordance with at least one of degradation of performance, presence/absence of a malfunction, an external environment, and the like for the detection device DD.

In a case in which the reliability is equal to or less than a threshold, the management unit 172 determines that the reliability is lowered. For example, in a case in which average luminance of an image captured by the camera 40 has a value equal to or less than a threshold, a case in which the amount of change in luminance is equal to or less than a predetermined range (for example, a case in which the field of vision is bad due to darkness, fog, backlight, or the like), a case in which a recognition rate of objects on an image, characters and lines on a road from a captured image for every predetermined time is equal to or less than a predetermined threshold on the basis of a result of image analysis using a GPU, or the like, the management unit 172 can determine that the reliability is equal to or less than a threshold.

In addition, for example, in a case in which redundancy for detection areas of one or more detection devices DD is decreased, the management unit 172 may output a request for causing a vehicle occupant to perform monitoring to the request information generating unit 174. For example, in a case in which a state detected by a plurality of detection devices DD is damaged for a certain area, the management unit 172 determines that redundancy for the area is decreased.

FIG. 12 is a diagram illustrating one example of the surrounding monitoring information. The surrounding management information illustrated in FIG. 12 represents detection devices DD and detection targets managed by the management unit 172. In the example illustrated in FIG. 12, a “camera,” a “GPU,” a “LIDER,” and a “radar” are illustrated as examples of the detection devices DD. In addition, although a “partition line (a left line of the subject vehicle),” a “partition line (a right line of the subject vehicle),” a “preceding vehicle,” and a “following vehicle” are illustrated as examples of the detection targets, the detection targets are not limited thereto. Thus, for example, a “right vehicle,” a “left vehicle,” and the like may be detected.

In the example illustrated in FIG. 12, the “camera” corresponds to the camera 40 described above. The “GPU” is a detection device that performs recognition or the like of a surrounding environment of the subject vehicle and objects inside an image by performing image analysis of the image captured by the camera 40. The “LIDER” corresponds to the finder 20 described above. In addition, the “radar” corresponds to the radar 30 described above.

For example, the vehicle control system 100 increases detection accuracy by using detection results acquired by a plurality of detection devices DD for one detection target, and by performing redundancy of detection in this way, safety of the subject vehicle M in automated driving and the like is maintained.

Here, for example, in a case in which the subject vehicle M is in the automated driving mode, and the reliability of at least one detection result among a plurality of detection results for one detection target is lowered or a case in which redundancy for detection areas of one or more detection devices is decreased, it is necessary to switch to a driving mode such as a manual driving mode of which a degree of automated driving is low. In such a case, there is a likelihood of the degree of automated driving being decreased due to the state of the subject vehicle M or the outside of the vehicle, and a vehicle occupant performs manual driving whenever the degree of automated driving is decreased, whereby there is a load.

Thus, in this embodiment, even in a case in which there is a change in the state of the detection device DD, control of maintaining automated driving is performed by temporarily requesting a vehicle occupant to perform monitoring of a part of the surroundings. For example, the management unit 172 compares a detection result acquired by each detection device DD with a threshold set for each detection device DD or each detection area of the detection device DD. In a case in which the detection result is equal to or less than a threshold, the management unit 172 specifies the detection device. In addition, on the basis of a detection result, the management unit 172 sets a monitoring target area for a vehicle occupant of the subject vehicle M on the basis of one or both of a position of a detection device of which the reliability becomes a threshold or less and a detection target.

For example, the management unit 172 acquires a detection result acquired by each detection device DD for each detection target and determines that the reliability of the detection result is high (correctly detected) (“O” illustrated in FIG. 12) in a case in which the detection result exceeds a predetermined threshold. In addition, even in a case in which a detection result is acquired, when the detection result is equal to or less than a predetermined threshold, the management unit 172 determines that the reliability of the detection is low (detection is not correctly performed) (“X” illustrated in FIG. 12).

For example, in a case in which a detection result as illustrated in FIG. 12 is acquired, a partition line (a right line of the subject vehicle) that is a detection target is detected only by the “radar.” In other words, the management unit 172 determines that the reliability of detection results acquired by the “camera,” the “GPU,” and the “LIDER” is lowered for the partition line (the right line of the subject vehicle). In other words, the management unit 172 determines that the redundancy is decreased in the detection of the partition line (the right line of the subject vehicle). In this case, the management unit 172 requests a vehicle occupant of the subject vehicle M to perform surrounding monitoring of the right side (monitoring target area) of the subject vehicle M (to monitor a part of the surroundings of the subject vehicle M).

In addition, the management unit 172 acquires the direction of a face, the posture, and the like of the vehicle occupant of the subject vehicle M by analyzing an image captured by the vehicle indoor camera 95, and in a case in which the instructed surrounding monitoring is correctly performed, may determine a state in which the vehicle occupant is monitoring the surroundings. In addition, in a case in which a state in which the steering wheel 78 is gripped by the hands or a foot is placed on the acceleration pedal 71 or the brake pedal 74 is detected, the management unit 172 may determine a state in which the vehicle occupant is monitoring the surroundings. Furthermore, in a case in which the state in which the vehicle occupant is monitoring the surroundings is determined, the management unit 172 continues a driving mode before the determination (for example, an automated driving mode). In this case, the management unit 172 may output information indicating continuation of the automated driving mode to the automated driving control unit 120.

In addition, in a case in which the state of the detection device DD is returned to the state before change, the management unit 172 may output information representing release of monitoring of the surroundings by the vehicle occupant to the request information generating unit 174. For example, in a case in which the reliability of the detection device of which the reliability has been a threshold or less exceeds the threshold, and the automated driving mode of the subject vehicle M is continued, the management unit 172 outputs information for releasing the monitoring of the surroundings by the vehicle occupant.

In addition, for example, in a case in which a vehicle occupant does not perform monitoring of the surroundings even when a predetermined time elapses after the vehicle occupant of the subject vehicle M is requested to monitor the surroundings, the management unit 172 may output an instruction for switching the driving mode of the subject vehicle M to a driving mode of which the degree of automated driving is low (for example, a manual driving mode) to the automated driving control unit 120 and output information indicating the switching to the request information generating unit 174. Furthermore, in a case in which a state in which the vehicle occupant is monitoring the surroundings continues for a predetermined time or more, the management unit 172 may output an instruction for switching the driving mode of the subject vehicle M to a driving mode of which the degree of automated driving is low to the automated driving control unit 120 and output information indicating the switching to the request information generating unit 174.

In a case in which it is necessary for the vehicle occupant of the subject vehicle M to monitor the surroundings on the basis of the information acquired by the management unit 172, the request information generating unit 174 outputs information used for requesting the vehicle occupant to monitor a part of the surroundings to HMI 70.

For example, the request information generating unit 174 generates an image that displays an area that is a target for a vehicle occupant of the subject vehicle M to perform monitoring of the surroundings (monitoring target area) and an area that is not a target area (non-monitoring target area) on a screen of the display device 82 to be distinguished from each other on the basis of the information acquired by the management unit 172.

In addition, the request information generating unit 174, for example, presents at least one of a monitoring target requested from the vehicle occupant, a monitoring technique, and a monitoring area using the HMI 70. In addition, in order to distinguish the areas described above from each other, the request information generating unit 174, for example, performs an emphasized display or the like such as increasing or decreasing the luminance of the monitoring target area relative to the other areas (non-monitoring target areas) or enclosing the monitoring target area using a line, a pattern, or the like.

In a case in which the necessity of the surrounding monitoring obligation of the vehicle occupant disappears, the request information generating unit 174 generates information indicating that the necessity of the surrounding monitoring obligation disappears. In this case, the request information generating unit 174 may generate an image in which the display of the surrounding monitoring target area is released.

In addition, in a case in which control of performing switching between the driving modes is performed, the request information generating unit 174 generates information indicating switching to a mode of which the degree of automated driving is low (for example, information used for requesting manual driving).

The interface control unit 176 outputs various kinds of information (for example, the generated screen) acquired from the request information generating unit 174 to the HMI 70 of the target. In addition, one or both of a screen output and a speech output may be used as the output to the HMI 70.

For example, by causing the HMI 70 to display only a part of an area required to be monitored by the vehicle occupant in a distinguished manner, the vehicle occupant can easily recognize the area. In addition, the vehicle occupant may monitor only a part of the area and has less of a burden than in a case in which the entire surrounding area of the subject vehicle M is monitored. In addition, since the driving mode is continued while the vehicle occupant performs the requested monitoring, frequent decreasing of the degree of automated driving due to the state of the subject vehicle or the outside the subject vehicle can be prevented.

When information of a mode of automated driving is notified of by the automated driving control unit 120, the interface control unit 176 controls the HMI 70 in accordance with a type of the mode of automated driving by referring to the operation permission/prohibition information 188 for each mode.

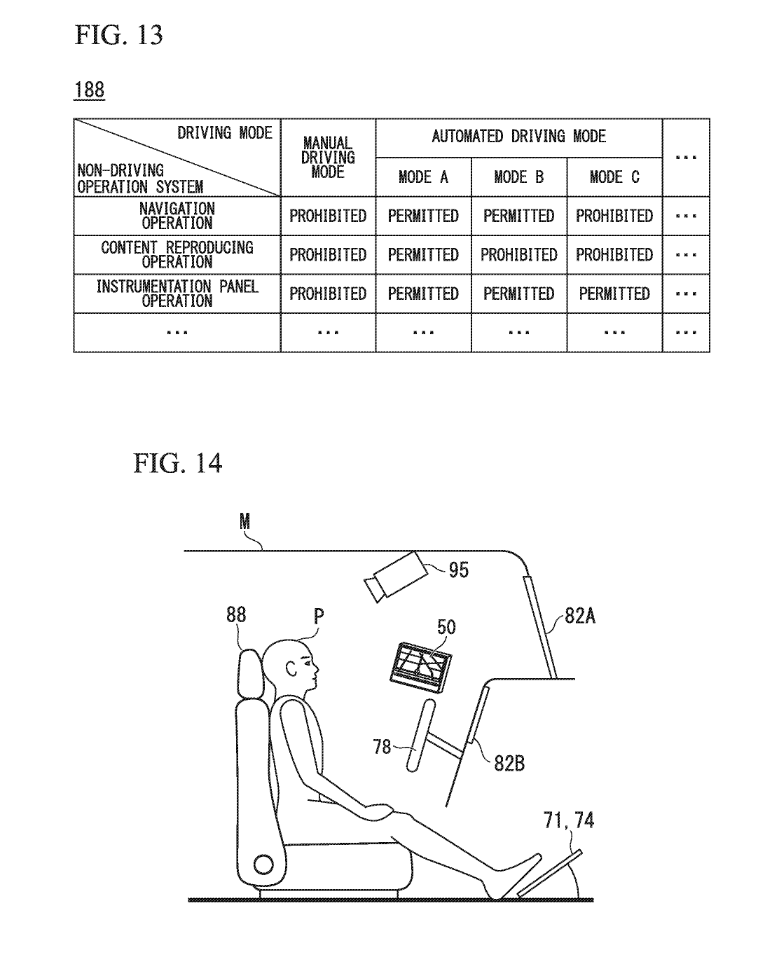

FIG. 13 is a diagram illustrating one example of the operation permission/prohibition information 188 for each mode. The operation permission/prohibition information 188 for each mode illustrated in FIG. 13 includes a “manual driving mode” and an “automated driving mode” as items of the driving mode. In addition, the operation permission/prohibition information 188 for each mode includes the “mode A,” the “mode B,” and the “mode C” described above and the like as the “automated driving modes.” Furthermore, the operation permission/prohibition information 188 for each mode includes a “navigation operation” that is an operation for the navigation device 50, a “content reproducing operation” that is an operation for the content reproducing device 85, an “instrument panel operation” that is an operation for the display device 82, and the like as items of the non-driving operation system. In the example of the operation permission/prohibition information 188 for each mode illustrated in FIG. 13, although permission/prohibition of a vehicle occupant's operation for the non-driving operation system is set for each driving mode described above, an interface device of the target (an output unit or the like) is not limited thereto.

By referring to the operation permission/prohibition information 188 for each mode on the basis of the information of the mode acquired from the automated driving control unit 120, the interface control unit 176 determines a device of which use is permitted and a device of which use is prohibited. In addition, the interface control unit 176 controls acceptance/non-acceptance of an operation from a vehicle occupant for the HMI 70 or the navigation device 50 of the non-driving operation system on the basis of a result of the determination.

For example, when a driving mode executed by the vehicle control system 100 is the manual driving mode, the vehicle occupant operates the driving operation system of the HMI 70 (for example, the acceleration pedal 71, the brake pedal 74, the shift lever 76, the steering wheel 78, or the like). On the other hand, in a case in which the driving mode executed by the vehicle control system 100 is the mode B, the mode C, or the like of the automated driving mode, the vehicle occupant has an obligation to monitor the surroundings of the subject vehicle M. In such a case, in order to prevent the occupant from being distracted by an action other than driving (for example, an operation of the HMI 70 or the like) (driver distraction), the interface control unit 176 performs control such that an operation for some or all of the non-driving operation system of the HMI 70 is not accepted. At this time, in order to perform monitoring of the surroundings of the subject vehicle M, the interface control unit 176 may display the presence of surrounding vehicles of the subject vehicle M and states of the surrounding vehicles recognized by the external system recognizing unit 142 on the display device 82 using an image or the like and cause the HMI 70 to accept a checking operation corresponding to a situation where the subject vehicle M is running

In addition, in a case in which the driving mode is the mode A of automated driving, the interface control unit 176 alleviates a restriction of driver distraction and performs control of accepting a vehicle occupant's operation for the non-driving operation system that has not been accepted. For example, the interface control unit 176 displays a video on the display device 82, causes the speaker 83 to outputs speech, or causes the content reproducing device 85 to reproduce content from a DVD or the like.

In the content reproduced by the content reproducing device 85, for example, various types of content relating to amusement and entertainment such as a television program may be included in addition to content stored in a DVD or the like. A “content reproducing operation” illustrated in FIG. 13 may represent an operation of content relating to such amusement or entertainment.

In addition, for example, for the request information (for example, a monitoring request or a driving request) generated by the request information generating unit 174, the monitoring release information, and the like described above, the interface control unit 176 selects a device (output unit) of the non-driving operation system of the HMI 70 that can be used in the current driving mode and displays the generated information on the screen of one or more devices that have been selected. In addition, the interface control unit 176 may output the generated information as speech using the speaker 83 of the HMI 70.

Next, one example of the surrounding monitoring request for a vehicle occupant according to this embodiment described above will be described with reference to the drawing. FIG. 14 is a diagram illustrating a view of the inside of the subject vehicle M. In the example illustrated in FIG. 14, a state in which a vehicle occupant P of the subject vehicle M sits on a seat 88 is illustrated, and the face and the posture of the vehicle occupant P can be imaged using the vehicle indoor camera 95. In the example illustrated in FIG. 14, as one example of an output unit (HMI 70) disposed in the subject vehicle M, a navigation device 50 and display devices 82A and 82B are illustrated. Here, the display device 82A is a head up display (HUD) integrally formed with the front windshield (for example, a front glass), and the display device 82B represents a display disposed on the instrument panel that is present in front of the vehicle occupant sitting on the driver's seat 88. In the example illustrated in FIG. 14, the acceleration pedal 71, the brake pedal 74, and the steering wheel 78 are illustrated as one example of the driving operation system of the HMI 70.

In this embodiment, for example, in accordance with control using the HMI control unit 170 described above, a captured image captured by the camera 40, various kinds of information generated by the request information generating unit 174, and the like are displayed on at least one of the navigation device 50, the display devices 82A and 82B, and the like in correspondence with a driving mode and the like.

Here, in a case in which display is performed for the display device 82A, the interface control unit 176 projects information representing one or both sides of a running locus generated by the locus generating unit 146 and various kinds of information generated by the request information generating unit 174 in association with a real space that is visible through the front windshield that is a projection destination of the HUD. In this way, the running locus, information of a request for monitoring a part of the surroundings of the subject vehicle M, driving request information, monitoring release information, and the like can be displayed directly in the field of view of the vehicle occupant P of the subject vehicle M. In addition, information such as the running locus and the request information described above may be displayed also in the navigation device 50 or the display device 82. The interface control unit 176 can display the running locus, the information of a request for monitoring a part of the surroundings of the subject vehicle M, the driving request information, the monitoring release information, and the like described above among a plurality of outputs in the HMI 70 in one or a plurality of output units.

Next, an example of a screen outputting request information and the like according to this embodiment will be described. Although the display device 82B will be used as one example of the output unit of which output is controlled by the interface control unit 176 in the following description, a target output unit is not limited thereto.

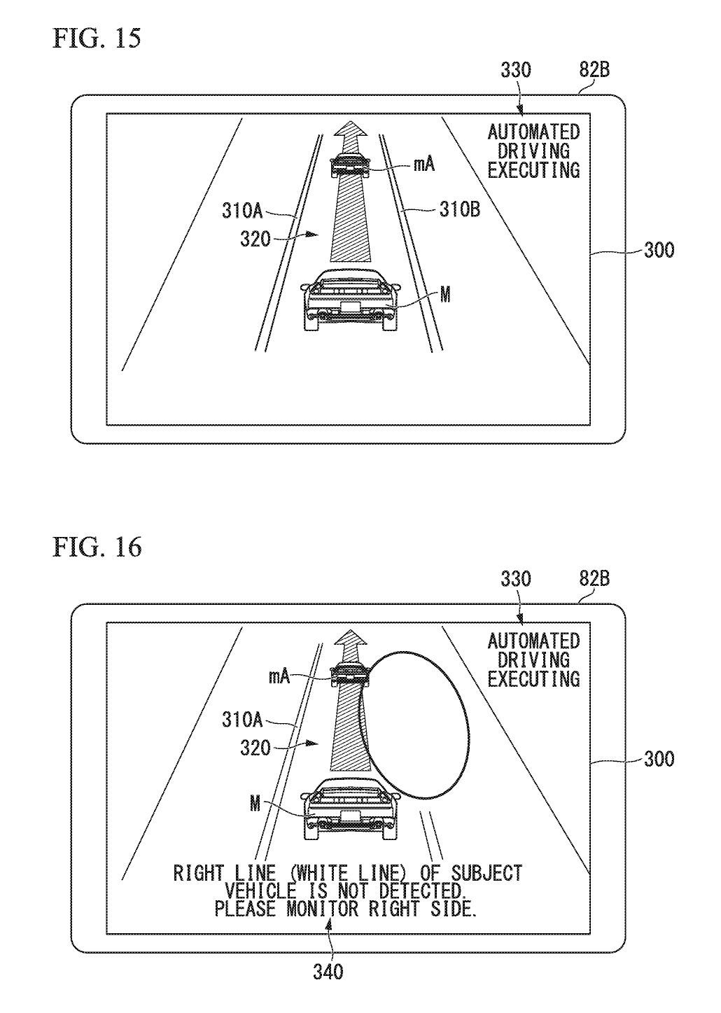

FIG. 15 is a diagram illustrating an example of an output screen according to this embodiment. In the example illustrated in FIG. 15, on the screen 300 of the display device 82B, partition lines (for example, white lines) 310A and 310B partitioning lanes of a road and a preceding vehicle mA running ahead of the subject vehicle M acquired by performing image analysis of an image captured by the camera 40 or the like are displayed. In addition, the image may be displayed as it is without performing the image analysis for the partition line 310, the preceding vehicle mA, and the like. Although an image corresponding to the subject vehicle M is also displayed in the example illustrated in FIG. 15, the image may not be displayed, or only a part (for example, a front part) of the subject vehicle M may be displayed.

For example, although locus information (an object of a running locus) 320 generated by the locus generating unit 146 or the like is displayed to be superimposed on the screen 300 or integrated with the image captured by the camera 40 in the example illustrated in FIG. 15, the locus information may not be displayed. In addition, the locus information 320, for example, may be generated either by the request information generating unit 174 or by the interface control unit 176. In this way, the vehicle occupant can easily recognize a behavior (running) of the subject vehicle M to be performed. In addition, the interface control unit 176 may display driving mode information 330 representing the current driving mode of the subject vehicle M on the screen 300. In the example illustrated in FIG. 15, although “automated driving in progress” is displayed on the upper right side of the screen in a case in which the automated driving mode is executed, a display position and display content are not limited thereto.

Here, for example, in a case in which reliability (for example, performance, a malfunction or an external environment) of detection results acquired by one or more detection devices DD is lowered, the management unit 172 outputs a request causing a vehicle occupant of the subject vehicle to M monitor the surroundings of the subject vehicle M. For example, in a case in which it is determined that the right partition line 310B of the subject vehicle M cannot be detected in the surrounding monitoring information illustrated in FIG. 12 described above, the management unit 172 notifies the vehicle occupant of a request for monitoring an area on the right side among the surroundings of the subject vehicle M.

Reasons for not being able to detect the partition line described above, for example, include partial disappearance of the partition line 310 of the road (including a case of being blurred), a state in which snow or the like is piled on the partition line 310B or the detection device DD detecting the partition line 310B, a state in which the partition line 310B is indistinguishable, and the like. In addition, there are cases in which the reliability of a detection result is lowered due to the influence of weather (weather conditions) such as temporary fog or heavy rain. In such cases as well, since the left partition line 310A of the subject vehicle M is recognized, the running lane can be maintained with reference to the partition line 310A.

FIGS. 16 to 18 are diagrams illustrating examples (1 to 3) of screens on which information requesting monitoring of the surroundings is displayed. The interface control unit 176 outputs monitoring request information (for example, at least one of a monitoring target, a monitoring technique, and a monitoring area requested for the vehicle occupant) generated by the request information generating unit 174 to the screen 300 included in the display device 82B.

In the example illustrated in FIG. 16, the interface control unit 176 displays a predetermined message on the screen 300 of the display device 82B as the monitoring request information 340. As the monitoring request information 340, for example, information (a monitoring target and a monitoring technique) such as “A line (white line) of the vehicle on the right side has not been detected. Please monitor the right side” on the screen 300, and a content that is displayed is not limited thereto. In addition, the interface control unit 176 may output the same content as the monitoring request information 340 described above through the speaker 83 as speech.

In addition, the interface control unit 176, as illustrated in FIG. 16, may display a monitoring target area (monitoring area) 350 to be monitored by the vehicle occupant on the screen 300. A plurality of monitoring target areas 350 may be disposed on the screen 300. A predetermined emphasized display is applied to the monitoring target area 350 such that it can be distinguished from a non-monitoring target area. The emphasized display, for example, as illustrated in FIG. 16, is at least one of emphasized displays of enclosing an area using a line, changing the luminance of the inside of the area to be different from surrounding luminance, lighting or flashing the inside of the area, attaching a pattern, a symbol, or the like, and the like. The screen of such an emphasized display is generated by the request information generating unit 174.

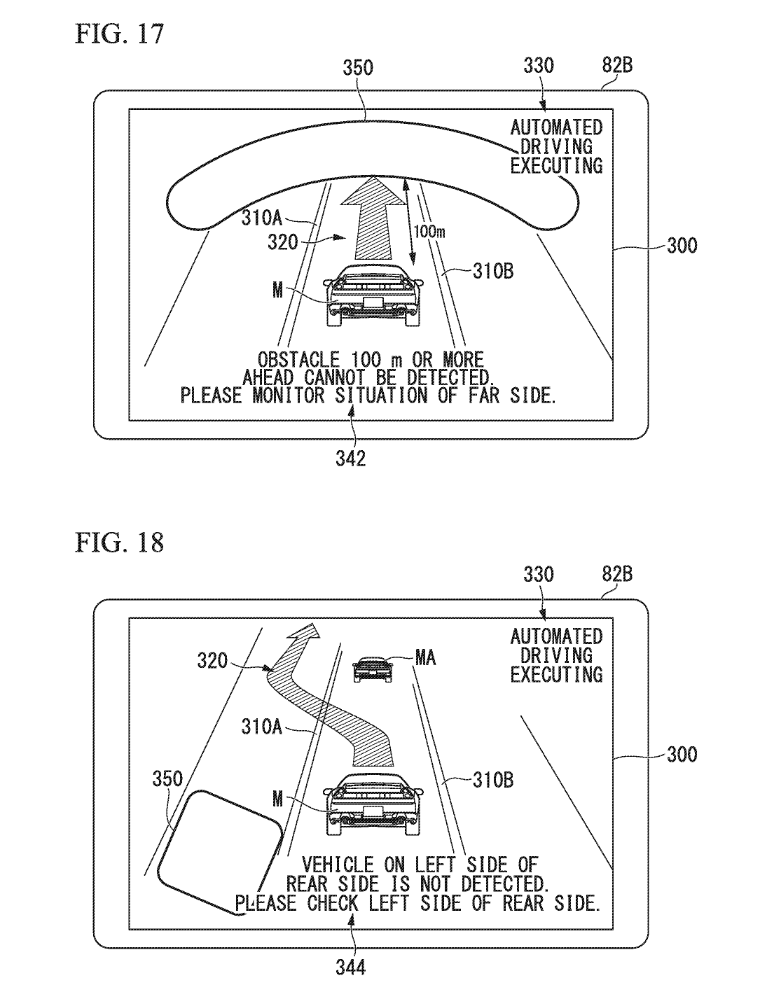

In addition, in the example illustrated in FIG. 17, in a case in which an obstacle or the like disposed 100 [m] or more ahead cannot be detected, the interface control unit 176 displays, for example, information (a monitoring target and a monitoring technique) of “An obstacle disposed 100 [m] or more ahead cannot be detected. Please monitor a situation of a place located far!” or the like on the screen 300 of the display device 82B as the monitoring request information 342. In addition, the interface control unit 176 may output the same content as the monitoring request information 342 described above through the speaker 83 as speech and may display the monitoring target area 350 monitored by the vehicle occupant on the screen 300.

As illustrated in the example illustrated in FIG. 18, in the running locus of the subject vehicle M, in a case in which lane changing is made to the left lane (locus information 320 illustrated in FIG. 18) and in a case in which a vehicle running behind on the left side cannot be detected, the interface control unit 176, for example, displays information (a monitoring target and a monitoring technique) of “A vehicle running behind on the left side cannot be detected. Please check the rear side on the left side!” or the like on the screen 300 of the display device 82B as the monitoring request information 344. In addition, the interface control unit 176 may output the same content as the monitoring request information 342 described above through the speaker 83 as speech and may display the monitoring target area 350 monitored by the vehicle occupant on the screen 300. As described above, in this embodiment, details of a monitoring request for a vehicle occupant are specifically notified including at least one of a monitoring target, a monitoring technique, and a monitoring area. Accordingly, a vehicle occupant can easily recognize a monitoring target, a monitoring technique, a monitoring area, and the like.

Here, for example, within a predetermined time, when the reliability of a detection result acquired by the detection device DD exceeds a threshold, and a state in which the right partition line 310B on the right side of the subject vehicle M described above can be detected is formed, the management unit 172 displays information indicating that a surrounding monitoring obligation of the vehicle occupant is not necessary on the screen

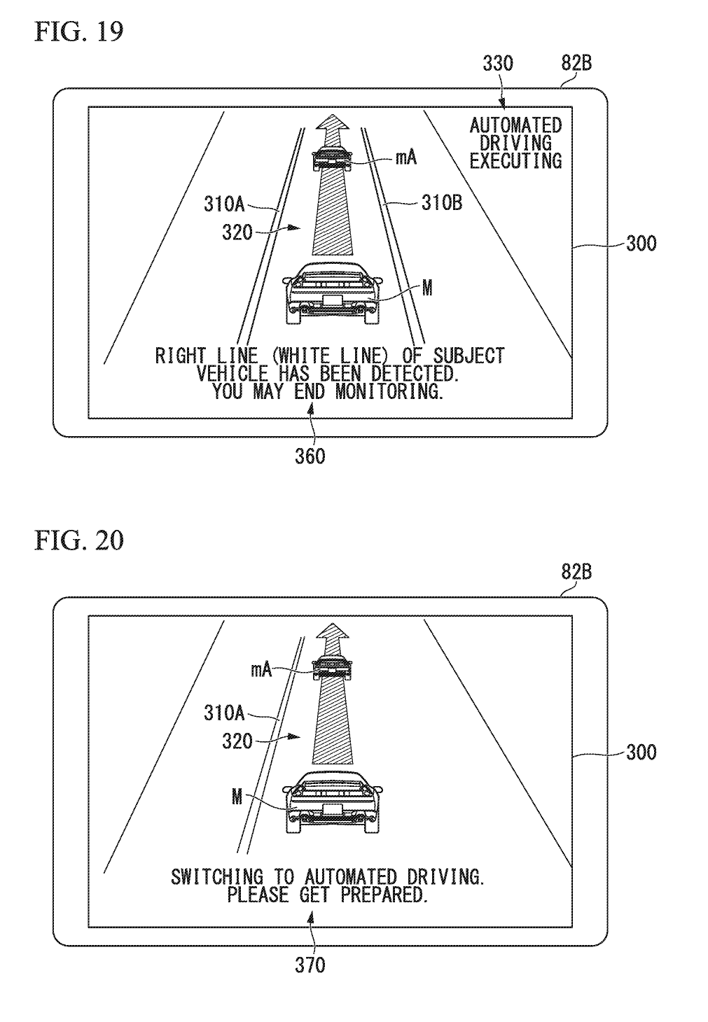

FIG. 19 is a diagram illustrating an example of a screen on which information representing that the monitoring state has been released is displayed. In the example illustrated in FIG. 19, a predetermined message as monitoring release information 360 is displayed on the screen 300 of the display device 82B. As the monitoring release information 360, for example, although information of “A line (white line) on the right side of the subject vehicle has been detected. You may end monitoring” or the like is displayed, details to be displayed are not limited thereto. In addition, the interface control unit 176 may output the same content as the monitoring release information 360 described above through the speaker 83 as speech.

In addition, for example, in a case in which a state in which the reliability of a detection result acquired by the detection device DD is equal to or less than a threshold continues for a predetermined time or more, the management unit 172 displays information indicating execution of switching between driving modes on the screen.

FIG. 20 is a diagram illustrating an example of a screen on which information representing a driving mode switching request is displayed. In the example illustrated in FIG. 20, in a case in which a state in which the reliability of a detection result acquired by the detection device DD is equal to or less than a threshold continues for a predetermined time or more, the driving mode is switched to a driving mode of which the degree of automated driving is low (for example, a manual driving mode), and thus, a predetermined message is displayed on the screen 300 of the display device 82B as the driving request information 370. For example, although information of “Switching to the manual driving. Please get ready!” or the like is displayed as the driving request information 370, a content to be displayed is not limited thereto. In addition, the interface control unit 176 may output the same content as the driving request information 370 described above through the speaker 83 as speech.

In addition, for example, the interface control unit 176 may not only output the screens illustrated in FIGS. 15 to 20 described above but also display a detection state of each detection device DD as illustrated in FIG. 12.

In addition, in the example described above, in a case in which reliability of a detection result of one or more detection devices DD is lowered, although the HMI control unit 170 outputs a request for the execution of monitoring a part of the surroundings of the subject vehicle M or the like to the HMI 70, the output is not limited thereto. For example, in a case in which redundancy for detection areas of one or more detection devices DD is decreased, the HMI control unit 170 may output a request for the execution of monitoring surroundings of the subject vehicle M to the HMI 70.

### [Process Flow]

Hereinafter, the flow of a process executed by the vehicle control system 100 according to this embodiment will be described. In the following description, among various processes of the vehicle control system 100, a surrounding monitoring request process executed by the HMI control unit 170 will be mainly described.

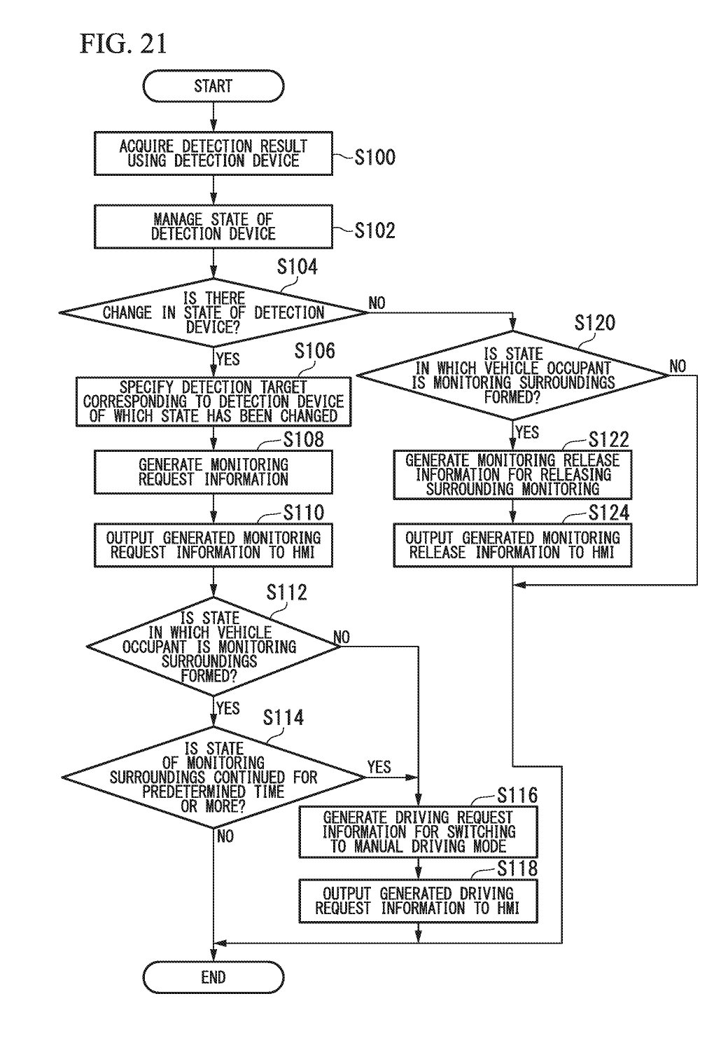

FIG. 21 is a flowchart illustrating one example of the surrounding monitoring request process. In the example illustrated in FIG. 21, a case in which the driving mode of the subject vehicle M is an automated driving mode (mode A) is illustrated. In the example illustrated in FIG. 21, the management unit 172 of the HMI control unit 170 acquires a detection result of one or more detection devices DD mounted in the subject vehicle M (Step S100) and manages the state of each detection device DD (Step S102).

Next, the management unit 172 determines whether or not there is a change in the state (for example, a decrease in the reliability or redundancy), for example, based on the reliability, redundancy, or the like described above in one or more detection devices DD (Step S104). In a case in which there is a change in the state of one or more detection devices DD, the management unit 172 specifies a detection target corresponding to the detection device DD of which the state has been changed (Step S106).

Next, the request information generating unit 174 of the HMI control unit 170 generates monitoring request information for causing the vehicle occupant of the subject vehicle M to monitor surroundings at predetermined position on the basis of the information (for example, a detection target) specified by the management unit 172 (Step S108). Next, the interface control unit 176 of the HMI control unit 170 outputs the monitoring request information generated by the request information generating unit 174 to the HMI 70 (for example, the display device 82) (Step S110).

Next, the management unit 172 determines a state in which the vehicle occupant is executing requested monitoring the surroundings on the basis of a management request or not (Step S112). Whether or not the requested surrounding monitoring is executed can be determined on the basis of whether or not requested monitoring of a part of the surroundings of the subject vehicle M is executed, for example, on the basis of the position of a face, the direction of a sight line, a posture, and the like of the vehicle occupant acquired by analyzing an image captured by the vehicle indoor camera 95. In a case in which a state in which the vehicle occupant is monitoring a requested monitoring target is formed, the management unit 172 determines whether or not the state in which the vehicle occupant is monitoring continues for a predetermined time or more (Step S114).

Here, in the process of Step S112 described above, in a case in which the state in which the vehicle occupant is monitoring the surroundings, which has been requested, is not formed or in a case in which the state in which the surroundings are monitored continues for a predetermined time or more, the request information generating unit 174 generates useful driving request information for switching the driving mode of the subject vehicle M to the manual driving mode (for example, handover control is executed) (Step S116). In addition, the interface control unit 176 outputs the driving request information generated by the request information generating unit 174 to the HMI (Step S118).

In addition, in the process of Step S104 described above, in a case in which there is no change in the state of the detection device DD, the management unit 172 determines whether or not a state in which the vehicle occupant is monitoring the surroundings is formed (Step S120). In a case in which the state in which the vehicle occupant is monitoring the surroundings is formed in Step S120 described above, the request information generating unit 174 generates monitoring release information for releasing the monitoring of the surroundings (Step S122). Next, the interface control unit 176 outputs the generated monitoring release information to the HMI 70 (Step S124). On the other hand, in a case in which the state in which the vehicle occupant is monitoring the surroundings is not formed in Step S120, the process of this flowchart ends. In addition, also after the process of Step 5114 and Step 5118 described above, the process of this flowchart ends.

In addition, for example, in a case in which the subject vehicle M is in the automated driving mode, the surrounding monitoring request process illustrated in FIG. 21 may be repeatedly executed at predetermined time intervals.

According to the embodiment described above, the state of one or more detection devices DD is managed, and a request for causing a vehicle occupant to monitor a part of the surroundings of the subject vehicle is output in accordance with a change in the state of one or more detection devices by controlling the HMI 70, and accordingly, the vehicle occupant is caused to monitor a part of the surroundings in automated driving, whereby the automated driving can be continued. In addition, since a part is monitored, the burden on the vehicle occupant can be alleviated. For example, in this embodiment, in a case in which the reliability of sensing of an external system using the detection device DD is equal to or less than a threshold or in a case in which the redundancy of detection cannot be achieved, a monitoring target area is specified, a surrounding monitoring obligation is set for the specified part area, and the vehicle occupant is caused to monitor the part area. In addition, while the vehicle occupant is executing monitoring, the driving mode of the subject vehicle M is maintained. Accordingly, it can be prevented that the degree of automated driving is frequently decreased in accordance with the state of the vehicle or the outside of the vehicle, and the driving mode can be maintained. Therefore, according to this embodiment, cooperative driving between the vehicle control system 100 and the vehicle occupant can be realized.

As above, while the embodiments of the present invention have been described using the embodiment, the present invention is not limited to such embodiment at all, and various modifications and substitutions may be made in a range not departing from the concept of the present invention.

### INDUSTRIAL APPLICABILITY

The present invention can be used in a car manufacturing industry.

### REFERENCE SIGNS LIST

20 Finder

30 Radar

40 Camera

DD Detection device

50 Navigation device

60 Vehicle sensor

70 HMI

100 Vehicle control system

110 Target lane determining unit

120 Automated driving control unit

130 Automated driving mode control unit

140 Subject vehicle position recognizing unit

142 External system recognizing unit

144 Action plan generating unit

146 Locus generating unit

146A Running mode determining unit

146B Locus candidate generating unit

146C Evaluation/selection unit

150 Switching control unit

160 Running control unit

170 HMI control unit

172 Management unit

174 Request information generating unit

176 Interface control unit

180 Storage unit

200 Running driving force output device

210 Steering device

220 Brake device

M Subject vehicle

What is claim is:

1.-11. (canceled)

12. A vehicle control system comprising:
an automated driving control unit automatically performing at least one of speed control and steering control of a vehicle by executing one a plurality of driving modes of which degrees of automated driving are different from each other;
one or more detection devices used for detecting a surrounding environment of the vehicle; and
a management unit managing detection states of the one or more detection devices and outputting a request used for causing a vehicle occupant of the vehicle to monitor a part of the surroundings of the vehicle in accordance with a change in the detection states of the one or more detection devices by controlling an output unit.

13. The vehicle control system according to claim 12,
wherein the management unit outputs a request used for causing the vehicle occupant of the vehicle to monitor an area corresponding to the change in the detection state of the one or more detection devices by controlling the output unit.

14. The vehicle control system according to claim 12,
wherein the management unit manages reliability of a detection result for each of the one or more detection devices or for each of detection areas of the one or more detection devices and outputs a request used for causing the vehicle occupant of the vehicle to monitor a part of the surroundings of the vehicle in a case in which the reliability is lowered as a change in the detection state by controlling the output unit.

15. The vehicle control system according to claim 12,
wherein, in a case in which redundancy is decreased for the detection areas of the one or more detection devices as a change in the detection state, the management unit outputs a request used for causing the vehicle occupant of the vehicle to monitor a part of the surroundings of the vehicle by controlling the output unit.

16. The vehicle control system according to claim 12,
wherein the output unit further includes a screen displaying an image, and
wherein the management unit displays a target area for monitoring the surroundings for the vehicle occupant of the vehicle and an area other than the target area for monitoring the surroundings on the screen of the output unit to be distinguished from each other.

17. The vehicle control system according to claim 12,
wherein the output unit outputs at least one of a monitoring target, a monitoring technique, and a monitoring area requested for the vehicle occupant.

18. The vehicle control system according to claim 12,
wherein, in a case in which a state in which the vehicle occupant of the vehicle is monitoring a part of the surroundings of the vehicle is determined by the management unit, the automated driving control unit continues a driving mode that is a driving mode before the change in the detection state of the detection device.

19. The vehicle control system according to claim 12,
wherein, in a case in which a state in which the vehicle occupant of the vehicle is not monitoring a part of the surroundings of the vehicle is determined by the management unit, the automated driving control unit performs control of switching from a driving mode of which a degree of automated driving is high to a driving mode of which a degree of automated driving is low.

20. The vehicle control system according to claim 12,
wherein, in a case in which the detection state of the detection device is returned to the state before the change, the management unit outputs information indicating release of the vehicle occupant's monitoring by controlling the output unit.

21. The vehicle control system according to claim 12,
wherein the management unit temporarily performs a request for causing the vehicle occupant of the vehicle to execute monitoring and outputs a request for executing control of switching from a driving mode of which a degree of automated driving is high to a driving mode of which a degree of automated driving is low in a case in which a state in which the vehicle occupant of the vehicle is monitoring the surroundings is continued for a predetermined time or more by controlling the output unit.

22. A vehicle control method using an in-vehicle computer, the vehicle control method comprising:
automatically performing at least one of speed control and steering control of a vehicle by executing one of a plurality of driving modes of which degrees of automated driving are different from each other;
detecting a surrounding environment of the vehicle using one or more detection devices; and
managing detection states of the one or more detection devices and outputting a request used for causing a vehicle occupant of the vehicle to monitor a part of the surroundings of the vehicle in accordance with a change in the detection states of the one or more detection devices by controlling an output unit.

23. A vehicle control program causing an in-vehicle computer to execute:
automatically performing at least one of speed control and steering control of a vehicle by executing one of a plurality of driving modes of which degrees of automated driving are different from each other;
detecting a surrounding environment of the vehicle using one or more detection devices; and
managing detection states of the one or more detection devices and outputting a request used for causing a vehicle occupant of the vehicle to monitor a part of the surroundings of the vehicle in accordance with a change in the detection states of the one or more detection devices by controlling an output unit.
